(19) United States
(12) Patent Application Publication
(10) Pub. No.: US 2016/0061971 A1
(43) Pub. Date: Mar. 3, 2016

(54) DATA ACQUISITION APPARATUS USING ONE SINGLE LOCAL CLOCK

(71) Applicant: SERCEL, Carquefou (FR)

(72) Inventor: Jérôme LAINE, Sautron (FR)

(21) Appl. No.: 14/833,227

(22) Filed: Aug. 24, 2015

(30) Foreign Application Priority Data
Aug. 29, 2014 (EP) 14306340.2

(51) Int. Cl. G01V 1/22

(52) U.S. Cl. CPC G01V 1/223

(57) ABSTRACT

A seismic data acquisition apparatus includes a receiving antenna for receiving synchronization information representative of a remote reference clock signal; a local clock circuit delivering a local clock signal (CLK); a gauging circuit adapted to measure a frequency drift and a phase error of the local clock signal (CLK) in view of the synchronization information; an analog-to-digital converter adapted to provide a series of digital sampled and dated seismic data according to the local clock signal (CLK) and representative of the received seismic signal; and a correcting circuit configured to provide corrected series of digital sampled and dated seismic data based at least on the measured frequency drift and phase error.

### 1. FIELD OF THE INVENTION

The field of the invention is that of data acquisition systems. More specifically, the invention pertains to a data acquisition apparatus comprising an analog-to-digital converter, the apparatus being intended to form a node of a data acquisition system. All the nodes must be synchronized so that they all have the same sampling time.

The present invention can be applied notably but not exclusively to the field of seismic data acquisition systems.

### 2. TECHNOLOGICAL BACKGROUND

There are numerous data acquisition apparatuses and methods intended to be implemented within a data acquisition system. This is the case for example in the field of seismic data acquisition system. The invention of course is not limited to this particular field of application but is of interest for any technique for data acquisition that has to cope with closely related or similar issues and problems.

Typically, a seismic data acquisition system includes a network connected to a central unit.

In a first known implementation, the network includes a plurality of wired acquisition lines. Each wired acquisition line includes nodes (data acquisition apparatuses) and concentrators, thus all seismic data can be received in the central unit in a real-time manner. The nodes are assembled in series along a telemetry cable and are each associated with at least one seismic sensor (in general, strings of seismic sensors). These nodes process signals transmitted by the seismic sensor(s) and generate data. The concentrators are assembled in series along the telemetry cable and are each associated with at least one of the nodes. Each concentrator receives the data generated by the node(s) with which it is associated. The sensors are either analog sensors or digital sensors. When analog sensors (also referred to as “geophones”) are used, they are generally interconnected by cables to form clusters referred to as “strings of geophones”. One or several of these strings of geophones (in series or in parallel) are connected to each node (in this case, a node is also referred to as FDU, for “Field Digitizing Unit”) and this latter performs an analog to digital conversion of the signal from the groups of geophones and send these data to the central unit. When digital sensors are used (e.g. micro-machined accelerometers, also referred to as “MEMS-based digital accelerometer”), they are integrated in the nodes (in this case, a node is also referred to as DSU, for “Digital Sensor Unit”), which eliminates the geophone strings. Each node integrates one or several digital sensors.

In a second known implementation, the network includes wireless seismic acquisition units (also referred to as RAU, for “Remote Acquisition Units”). Each wireless seismic acquisition unit is independent and associated with (i.e. is connected to or integrates one or several functions of) one or several of aforesaid nodes. Each wireless seismic acquisition unit communicates wirelessly (directly or through one or several other wireless seismic acquisition units and/or through one or several of aforesaid concentrators) with the central unit and/or with a harvesting device (carried by an operator also referred to as “harvester”) if a data harvesting strategy is implemented. The set of wireless seismic acquisition units could constitute a multi-hop wireless mesh network, allowing the wireless seismic acquisition units to exchange data, between them and with the central unit. Thus, each wireless seismic acquisition unit stores its own data (i.e. data obtained from the node(s) with which it is associated) and, eventually, also stores data received from one or several other wireless seismic acquisition units (i.e. data obtained from the node(s) associated with this or these other wireless seismic acquisition units). The sensors are either analog sensors or digital sensors. When analog sensors (“geophones”) are used, each wireless seismic acquisition unit integrates for example one or a plurality of aforesaid nodes (as described for the first known implementation with geophones). When digital sensors are used, each wireless seismic acquisition unit is for example connected to a node which integrates one or several digital sensors (as described for the first known implementation with digital sensors).

A classical technical problem related to such data acquisition systems—and especially to wireless data acquisition systems—is to provide all the data acquisition apparatuses (nodes) the same time reference in order to fulfill the accuracy that seismic operations require.

In a first known solution, each node extracts and maintains this sampling reference clock thanks to a phase-locked loop system (PLL) controlling a local oscillator. In this way, the oscillator is slaved to an external time reference that may be provided by a GNSS (Global Navigation Satellite System) receiver for example. The use of a VCXO (voltage controlled crystal oscillator) controlled by a PLL has a high cost and a high energy consumption and involves strong hardware requirements for transmitting the sampling reference clock.

Document U.S. Pat. No. 8,260,580 proposes another data acquisition apparatus to alleviate the above-mentioned inconvenience, making it possible to obtain accurate acquisition data while minimizing energy consumption, computing load and memory load. As presented here below with reference to FIG. 1, such a data acquisition apparatus 1 includes, in at least one embodiment:
a receiving circuit 6, for example a GPS (Global Positioning System) receiver, comprising a first local clock circuit 60, a first gauging circuit 61, and a calculation circuit 62;
an analog-to-digital converter (ADC) 3;
a second local clock circuit 2;
a second gauging circuit 5;
a correcting circuit 4.

The analog-to-digital converter 3 samples data acquired by at least one sensor 10, at an imperfect sampling frequency provided by the local clock circuit 2. The correcting circuit 4 is then used to interpolate sampled data in order to compensate measured frequency drift and phase error of the clock signal CLK2 provided by the local clock circuit 2, thanks to the information given by the second gauging means 5. This prior art solution will be presented in greater detail in the detailed description of the present invention.

The inventors have noticed that, in the solution of document U.S. Pat. No. 8,260,580, two local clock circuits and two gauging circuits are used: a first local clock circuit 60 and a first gauging circuit 61, for generating a reference clock signal CLKREF at the output of the receiving circuit 6; a second local clock circuit 2, for sampling the data; and a second gauging circuit 5, for quantifying the drift of the clock signal CLK2 delivered by the second local clock circuit 2 in view of said reference clock signal CLKREF. Thus, both the data acquisition apparatus and the receiving circuit use their own local clock and their own gauging circuit for measuring frequency drift and phase error of a first input clock signal in view of a second input clock signal (which can be a synchronization information included in a radio communication signal). In other words, while seeking for a solution to further optimize such a data acquisition apparatus, the inventors have identified that some circuits that have the same functional goals (circuit for generating a clock signal, circuit for measuring frequency drift and phase error of a clock signal in view of another clock signal) are redundant. This approach is not efficient, as it leads to an increase of cost and power consumption of the data acquisition apparatus.

### 3. GOALS OF THE INVENTION

The invention, in at least one embodiment, is aimed especially at overcoming these different drawbacks of the prior art.

More specifically, it is a goal of at least one embodiment of the invention to propose a data acquisition apparatus, making it possible to minimize cost and energy consumption.

It is also an aim of at least one embodiment of the invention to propose a data acquisition apparatus of this kind for obtaining more accurate acquisition data.

### 4. SUMMARY OF THE INVENTION

A particular embodiment of the invention proposes a data acquisition apparatus including:
a receiving antenna, receiving a radio communication signal including synchronization information representative of a remote reference clock signal;
a local clock circuit, delivering a local clock signal (CLK);
a gauging circuit, measuring a frequency drift and a phase error of said local clock signal (CLK) in view of said synchronization information;
an analog-to-digital converter, providing a series of digital sampled and dated data according to said local clock signal (CLK);
a correcting circuit, correcting the series of digital sampled and dated data based at least on the measured frequency drift and phase error.

The general principle is that of:
using a single local clock signal (CLK) as input for both the gauging circuit and the analog-to-digital converter; and
using the frequency drift and phase error of the local clock signal (CLK) in view of the synchronization information, as input for the correcting circuit.

In other words, unlike the aforesaid known solution of FIG. 1, the data acquisition apparatus according to the proposed solution doesn't generate a reference clock signal (CLKREF), but directly use the frequency drift and phase error of the local clock signal (CLK) in view of the synchronization information, as input for the correcting circuit.

Thus, this implementation optimizes power consumption and cost of the data acquisition apparatus (compared to the aforesaid known solution of FIG. 1), since only one local clock circuit is used instead of two in the prior art solution and only one gauging circuit is used instead of two in the prior art solution.

Moreover, higher data accuracy is obtained, since the local clock frequency and phase calibration is done directly in view of the synchronization information included in the radio communication signal received, instead of being done in view of a “local” reference clock being itself generated from a previous local clock frequency and phase calibration.

According to a particular feature, the receiving antenna and the gauging circuit are comprised in a receiving circuit.

Thus the proposed solution is easy to implement since it is possible to use an existing and cheap receiving circuit.

According to a particular feature, the receiving circuit is a RF receiver.

In another embodiment, the receiving circuit is a GNSS receiver.

Thus, the synchronization information included in the radio communication received is reliable, and data accuracy is optimized.

According to a particular feature, the local clock circuit is external to the receiving circuit, and the data acquisition apparatus includes a switch for turning off at least partially the receiving circuit once the gauging circuit has measured the frequency drift and phase error.

Thus, the receiving circuit may be turned off for the duration of validity of the gauging, in order to minimize power consumption of the data acquisition apparatus.

In another embodiment, the local clock circuit is internal to the receiving circuit, and the data acquisition apparatus includes a switch for turning off at least partially the receiving circuit without turning off the local clock circuit once the gauging circuit has measured the frequency drift and said phase error.

Thus, the receiving circuit may be partially turned off for the duration of validity of the gauging, in order to minimize power consumption of the data acquisition apparatus.

According to a particular feature, the data acquisition apparatus is a seismic data acquisition unit.

In another embodiment, the invention pertains to a data acquisition method carried out by the above-mentioned data acquisition apparatus, and comprising the following steps:
a) receiving a radio communication signal including synchronization information representative of a remote reference clock signal;
b) delivering a local clock signal (CLK);
c) measuring a frequency drift and a phase error of said local clock signal (CLK) in view of said synchronization information;
d) providing a series of digital sampled and dated data according to said local clock signal (CLK); and
e) correcting the series of digital sampled and dated data based at least on the measured frequency drift and phase error.

According to a particular feature, the data acquisition method further includes a step f) of turning off at least partially a receiving circuit, which carries out said steps a) and c), once step c) has been carried out.

In another embodiment, step f) is carried out without turning off a local clock circuit, which is internal to the receiving circuit and generates the local clock signal (CLK).

### 5. LIST OF FIGURES

Other features and advantages of embodiments of the invention shall appear from the following description, given by way of indicative and non-exhaustive examples and from the appended drawings, of which:

FIG. 1, already described with reference to the prior art, shows the simplified structure of a data acquisition apparatus; and

FIG. 2 provides a schematic illustration of a data acquisition apparatus according to a first embodiment of the invention;

### 6. DETAILED DESCRIPTION

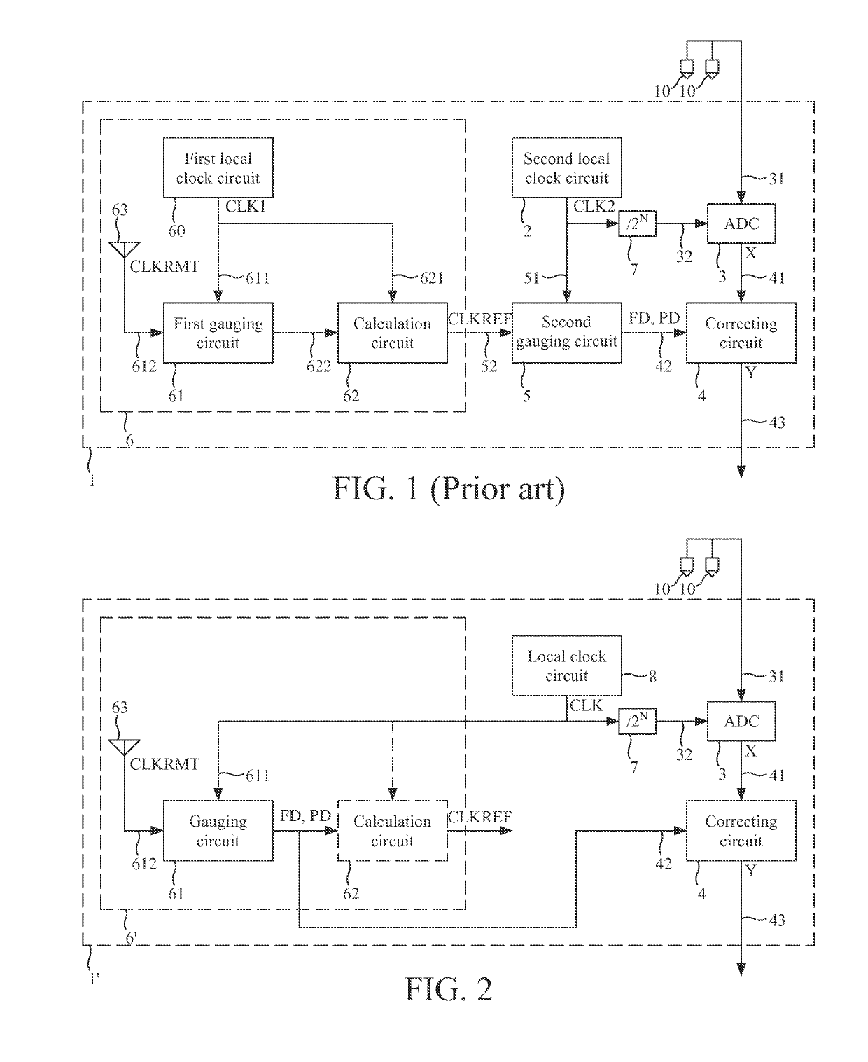

In all of the figures of the present document, identical elements and steps are designated by the same numerical reference sign. Referring now to FIG. 1 again, we present in greater detail one embodiment of a data acquisition apparatus as described in document U.S. Pat. No. 8,260,580. This data acquisition apparatus 1 is dedicated to the acquisition of seismic analog data measured by at least a sensor 10. Seismic analog data are sent to an analog data input 31. The apparatus 1 includes a local clock circuit 2, formed for example by a TCXO oscillator (temperature compensated crystal oscillator), and an analog-to-converter 3 for converting the analog data present on the analog data input 31 into first digital data samples X on its converter output. The converter 3 has a frequency input 32 connected to the local clock circuit 2. The frequency of the digital data samples X generated by the converter 3 is set by the frequency input 32.

A frequency adapter 7 may be inserted between the local clock circuit 2 and the frequency input 32, in order to adapt the frequency of the signal CLK2 provided by the local clock circuit 2 to the desired frequency FE on the frequency input 32. For example, the frequency adapter 7 may have a frequency divider to divide (e.g. by 2N) the frequency F₂ of the signal provided by the local clock circuit 2 into frequency F_{E} on the frequency input 32, in case frequency F_{E} is lower than the frequency F₂. In an example, the local clock circuit 2 produces a signal having a frequency F₂ of several MHz, like 8 Mhz, and F_{E}=256 kHz.

The value of the local clock frequency FE on input 32 is preset to cause an oversampling of the analog data input 31 by the converter 3, which is an analog-to-digital sigma-delta converter.

The converter output is connected to the data input 41 of a correcting circuit 4. The correcting circuit 4 is for example in the form of an interpolation filter. The correcting circuit 4 contains a means to produce on an interpolation output 43 data Y having said sampling frequency F_{E}. The data Y on interpolation output 43 is calculated through an interpolation function of the first one bit data samples X of data input 41. In the correcting circuit 4, the interpolation function F is calculated for each of the second data Y by a computation means using the frequency drift FD and the phase error PD of the clock signal CLK2 provided by the local clock circuit 2. The interpolation function F has a preset fixed degree. The correcting circuit 4 may be embodied by a FIR filter.

The frequency drift FD and phase error PD are calculated by a gauging means 5 having a first frequency input 51 connected to the local clock circuit 2 for receiving the imperfect periodic clock signal CLK2 supplied by said local clock circuit 2 having frequency F₂, and a second frequency input 52 connected to a reference clock output of a receiving circuit 6 for receiving a periodic reference clock signal CLKREF. In order to optimize costs, this receiving circuit is usually a mass-produced off-the-shelf component, not specifically dedicated to seismic data acquisition field. For example, the receiving circuit 6 supplying a reference clock signal is a satellite-based positioning system, such as a GPS receiver, or a simple RF receiver circuit. The periodic clock signal is represented by pulses or fronts or another signal pattern, called generally periodic time pattern repeating at frequency F₂ and able to be detected. The periodic reference clock signal CLKREF is represented by pulses or fronts or another signal pattern, or square signals called generally periodic time pattern repeating at a frequency F_{REF}, which may be equal to or different from frequency F₂ and which is also able to be detected. The receiving circuit 6 is used as a synchronization source supplying time-stamped signal, which are pulses.

An embodiment of the gauging circuit 5 is described hereunder.

The receiving circuit 6 supplies a reference frequency F_{REF}. The gauging circuit 5 measures frequency F₂ based on reference frequency F_{REF}. For example, in order to measure F₂, the number NF of periods of F₂ during the time interval defined by a number NFREF of periods of F_{REF} is counted by a counter. Then F₂ is obtained by: F₂=F_{REF}·NF/NFREF

Then, the frequency drift FD is obtained based on the measured frequency F₂ by FD=(F₂−F_{2-SET})/F_{2-SET}

wherein F_{2-SET} is a fixed and stored setting value of frequency for F₂.

FD represents the measured frequency error of the clock signal delivered by the local clock circuit 2. FD is expressed as a percentage value of actual TCXO frequency compared to typical value. The frequency drift FD is expressed in parts per million (ppm).

The gauging circuit 5 includes also a means to measure a phase shift representative of the phase error PD of the sampling signal sent to the analog-to-digital converter input 32 with respect to the reference clock signal CLKREF.

Means are provided to compensate the frequency drift FD and the phase error PD in the correcting circuit 4.

Once the gauging circuit 5 has performed a gauging of the frequency drift FD and phase error PD of the local clock signal, the receiving circuit may be turned off for the duration of validity of the gauging, thanks to appropriate means (not represented on FIG. 1). This make possible to save energy.

Data Y produced on the interpolation output 43 of the correcting circuit 4 may finally be sent to a decimation filter (not represented on FIG. 1), to produce final corrected digital data.

An embodiment of the receiving circuit 6 is described hereunder. A classical technique to obtain a reference clock signal in a wireless system is to measure frequency drift and phase error of a local clock signal in view of a synchronization information representative of a remote reference clock signal which is included in a radio communication signal received by a RF receiver. This local clock signal, which is delivered by a local clock circuit formed for example by a TCXO oscillator is then synchronized, based on the measured frequency drift and phase error, resulting in the generation of the reference clock signal. The local clock circuit can be part or not of the receiving circuit.

In some embodiments, the receiving circuit 6 is thus able to receive, by the means of a receiving antenna 63, a radio communication signal including synchronization information representative of a remote reference clock signal, and includes a local clock circuit 60, a gauging circuit 61, for measuring frequency drift and phase error of the local clock signal delivered by the local clock circuit 60 in view of said synchronization information, and a calculation circuit 62, able to synchronize said local clock signal based on said frequency drift and phase error. The gauging circuit 61 have a first frequency input 611 connected to the local clock circuit 60 for receiving the first imperfect periodic clock signal CLK1 supplied by said local clock circuit 60, and a second frequency input 612 for receiving the synchronization information representative of a remote reference clock signal CLKRMT. Frequency drift and phase error on the gauging circuit 61 output are sent to a first input 622 of the calculation circuit 62, while the imperfect periodic clock signal supplied by the local clock circuit 60 is sent to the second input 621 of the calculation circuit 62. The calculation circuit synchronizes the imperfect periodic clock signal supplied by the local clock circuit 60, based on the measured frequency drift and phase error, thus providing a reference clock signal on its output, which is also an output of the receiving circuit.

Referring now to FIG. 2, we present a data acquisition apparatus according to a first embodiment of the invention. This data acquisition apparatus incorporates some of the principles of operation previously described in FIG. 1, in particular using a correcting circuit to correct data sampled at an imperfect frequency delivered by a local clock circuit, based on the frequency drift and phase error of the local clock signal measured by a gauging circuit in view of a reference clock signal. But when the data acquisition apparatus according to prior art needs two local clock circuits and two gauging circuits, the data acquisition apparatus described hereunder needs only one local clock circuit and one gauging circuit.

As presented in greater detail here below, the data acquisition apparatus 1′ is dedicated to the acquisition of analog data measured by at least a sensor 10. Data may be seismic data, or another type. Examples of analog sensors are geophones, translation sensors, velocimeters, accelerometers, pressure sensors. Unlike the aforesaid known solution of FIG. 1, the data acquisition apparatus according to the proposed solution needs only one local clock circuit and one gauging circuit. The use of a single local clock circuit is made possible by the fact that the receiving circuit has means, for example sigma-delta fractional PLL (Phase-Locked Loop), for adapting any clock signal frequency (or at least wide range of frequencies) applied to its clock signal input to its desired operating frequency. Examples of receiving circuit are RF receiver or GNSS receiver (e.g. GPS receiver). The gauging circuit input 611 and the converter input 32 are now connected to the same single local clock circuit 8, instead of using the two local clock circuits numbered 2 and 60 on FIG. 1. Cost and power consumption are thus reduced compared to the solution of the prior art. This local clock circuit 8 is formed for example by a local oscillator such as a simple crystal oscillator, a TCXO oscillator (temperature compensated crystal oscillator) or a OCXO oscillator (oven-controlled crystal oscillator). The receiving circuit 6′ includes its own gauging circuit 61, which delivers frequency drift and phase error of the local clock signal CLK in view of the synchronization information included in the radio communication signal received trough the receiving antenna 63. These frequency drift and phase error information are sent directly to the correcting circuit 4, to be used to correct the series of the digital sampled and dated data X. In other words, there is no need for the second gauging circuit 5 for measuring a frequency drift and a phase error of the local clock signal in view of a reference clock signal, since this functionality is already achieved by the means of the gauging circuit 61 of the receiving circuit 6′, the synchronization information CLKRMT included in the radio communication signal being the reference clock. That means that the calculation circuit 62 of the receiving circuit 6′ is not used anymore in the scope of the data acquisition apparatus according to this particular embodiment.

As already described in prior art solution, a frequency adapter 7 may be inserted between the local clock circuit 8 and the frequency input 32, in order to adapt the frequency of the signal CLK provided by the local clock circuit 8 to the desired frequency FE on the frequency input 32 of the converter. In other embodiments of this invention, this frequency adapter 7 may be inserted upstream, immediately at the local clock circuit output, in order to adapt the frequency of the signal CLK provided by the local clock circuit 8 to the same desired frequency on the frequency inputs 611 and 32.

The embodiment presented in FIG. 2 shows a local clock circuit 8, which is external to the receiving circuit 6′. As already described in prior art solution, the data acquisition apparatus includes means (not represented) for turning off at least partially the receiving circuit 6′, once the gauging circuit 61 has performed a gauging of the frequency drift FD and phase error PD of the local clock signal CLK. The receiving circuit 6′ then stays turned off for the duration of validity of the gauging, thus making it possible to save energy. Before this duration of validity has elapsed, the receiving circuit is turned on and the gauging circuit 61 can then perform a new gauging.

In an alternative implementation, the local clock circuit 8 is internal to the receiving circuit 6′, but has its own power supply circuit. Therefore, it is still possible for the data acquisition apparatus to turn off at least partially the receiving circuit 6′ without turning off the local clock circuit 8.

In the embodiment described in FIG. 2, the receiving circuit is thus cleverly used for other purpose than its primary function. When a person skilled in the art would only use such a mass-produced off-the-shelf component for its well-known ability to provide a reference clock signal, the inventors had the idea of diverted this component from its intended use: they used it as a gauging means, by collecting internal data (frequency drift and phase error of the local clock signal) usually considered as simple intermediate data computed within the component, as a necessary step performed among others in order to fulfil more important functions.

This new approach has several advantages: since there is no use anymore for a specific second gauging circuit for measuring a second frequency drift and a second phase error of the local clock signal—the gauging circuit 61 already available in the receiver circuit 6′ being used—cost and power consumption are reduced. Moreover, higher accuracy is obtained, since the local clock frequency and phase calibration is done directly in view of the synchronization information included in the radio communication signal received, instead of being done it in view of a reference clock, said reference clock being itself generated from a previous local clock frequency and phase calibration.

According to the embodiment described in FIG. 2, the receiving circuit 6′ still includes a calculation circuit 62, even if this calculation circuit does not participate in implementing the technique proposed to obtain accurate acquisition data while minimizing energy consumption, computing load and memory load. Indeed, the reference clock CLKREF stays available if required to perform any other function within the data acquisition apparatus. According to an alternative embodiment, the receiving circuit does not comprise the calculation circuit anymore. To some extend, the receiving circuit is reduced to the minimum necessary to implement the previously described technique. The receiving circuit is then not necessary an off-the-shelf component anymore, but can be reduced to a simple combination of a receiving antenna—receiving a radio communication signal including synchronization information representative of a remote reference clock signal—in association with a gauging circuit, for measuring a frequency drift and a phase error of a local clock signal in view of this synchronization information.

According to another embodiment, the receiving antenna 63 and the gauging circuit 61 are not encapsulated in a receiving circuit 6 anymore.

1. A seismic data acquisition apparatus comprising:
a receiving antenna receiving a radio communication signal including synchronization information representative of a remote reference clock signal;
a local clock circuit delivering a local clock signal (CLK);
a gauging circuit with inputs for receiving synchronization information from the receiving antenna and for receiving the local clock signal from the local clock circuit, the gauging circuit being adapted to measure a frequency drift and a phase error of the local clock signal (CLK) in view of the synchronization information;
an analog-to-digital converter with an input for receiving the local clock signal from the local clock circuit and for receiving a seismic signal from sensors, the analog-to-digital converter being adapted to provide a series of digital sampled and dated seismic data according to the local clock signal (CLK) and representative of the received seismic signal; and
a correcting circuit with an input for receiving the frequency drift and phase error measured from the gauging circuit and the series of sampled and dated seismic data from the analog-to-digital converter, the correcting circuit providing corrected series of digital sampled and dated seismic data based at least on the measured frequency drift and phase error.

2. The seismic data acquisition apparatus according to claim 1, wherein the receiving antenna and the gauging circuit are comprised in a receiving circuit.

3. The seismic data acquisition apparatus according to claim 2, wherein the receiving circuit is a radio frequency (RF) receiver.

4. The seismic data acquisition apparatus according to claim 2, wherein the receiving circuit is a global navigation satellite system (GNSS) receiver.

5. The seismic data acquisition apparatus according to claim 2, wherein the local clock circuit is external to the receiving circuit, and wherein the data acquisition apparatus includes a switch for turning off at least partially the receiving circuit once the gauging circuit has measured the frequency drift and the phase error.

6. The seismic data acquisition apparatus according to claim 2, wherein the local clock circuit is internal to the receiving circuit, and wherein the data acquisition apparatus comprises a switch for turning off at least partially the receiving circuit without turning off the local clock circuit, once the gauging circuit has measured the frequency drift and the phase error.

7. The seismic data acquisition apparatus according to claim 1, wherein the data received by the analog-to-digital converter are analog, and the analog-to-digital converter is adapted to convert the analog data into digital data.

8. The seismic data acquisition apparatus according to claim 1, wherein the sensors are seismic sensors.

9. The seismic data acquisition apparatus according to claim 1, further comprising a calculation circuit.

10. A method for providing digital data from a seismic signal, the method comprising:
a) receiving a radio communication signal including synchronization information representative of a remote reference clock signal;
b) delivering a local clock signal (CLK);
c) receiving seismic signals from at least one sensor;
d) providing a series of digital sampled and dated seismic data according to said local clock signal (CLK) and representative of said seismic signals;
e) measuring a frequency drift and a phase error of said local clock signal (CLK) in view of said synchronization information;
f) correcting the series of digital sampled and dated seismic data based at least on the measured frequency drift and phase error; and
g) providing the digital data.

11. The method according to claim 10, wherein the seismic signals received in step c) are analog.

12. The method according to claim 10, wherein steps a) and e) are interrupted from time to time, and wherein steps d) and f) are continued during the interruption of steps a) and e), with a last local clock signal received from step a) being used in step d).

13. The method according to claim 10, wherein step b) is interrupted simultaneously with steps a) and e).

14. A seismic data node to be used in a seismic data acquisition system, the seismic data node comprising:
a local clock circuit delivering a local clock signal (CLK);
a receiving circuit receiving a radio communication signal including synchronization information representative of a remote reference clock signal, said receiving circuit providing a measure of the frequency drift and the phase error between said local clock signal (CLK) and said synchronization information;
an analog-to-digital converter with input for receiving the local clock signal from the local clock circuit and for receiving a seismic signal from sensors, said analog-to-digital converter being adapted to provide a series of digital sampled and dated seismic data according to said local clock signal (CLK) and representative of the received seismic signal;
a correcting circuit with input for receiving the frequency drift and phase error measured from the receiving circuit and the series of sampled and dated seismic data from the analog-to-digital converter, said correcting circuit providing corrected series of digital sampled and dated seismic data based at least on the measured frequency drift and phase error.

15. The seismic data node of claim 14, wherein the seismic data received by the analog-to-digital converter are analog, and said analog-to-digital converter is adapted to convert the analog data into digital data.

16. The seismic data node of claim 14, wherein there is no other local clock inside the node.

17. The seismic data node of claim 14, wherein the receiving circuit comprises:
an antenna for receiving the synchronization information; and
a gauging circuit for calculating the frequency drift and the phase error of the local clock signal.

18. The seismic data node of claim 14, wherein the gauging circuit and the analog-to-digital converter are both connected to the same local clock circuit.

19. The seismic data node of claim 14, further comprising:
an interface to be connected to the sensors, wherein the sensors are seismic sensors.

20. The seismic data node of claim 14, further comprising:
a switch for turning off at least partially the receiving circuit once the gauging circuit has measured the frequency drift and the phase error.
